(19) United States
(12) Patent Application Publication
(10) Pub. No.: US 2003/0034619 A1
(43) Pub. Date: Feb. 20, 2003

(54) Snowmobile ski and method of building same

(75) Inventor: Scott T. Bergstrom, Roscoe, IL (US)

Correspondence Address: LEYDIG VOIT & MAYER, LTD, 6815 WEAVER ROAD, ROCKFORD, IL, 61114-8018, US

(73) Assignee: Bergstrom Skegs, Inc., Machesney Park, IL (US)

(21) Appl. No.: 09/933,376

(22) Filed: Aug. 20, 2001

(51) Int. Cl. B62D 57/00

(52) U.S. Cl. 280/28

(57) ABSTRACT

A snowmobile ski built from strips of plastic to selectively form the bottom contour on the ski body of the snowmobile ski. The strips of plastic may be used to build a new ski or rebuild/reconstruct an existing snowmobile ski that has a center keel. The snowmobile ski comprises mounting shoe for mounting the snowmobile ski to the snowmobile and a longitudinally extending plastic ski body having an upwardly curved front tip toward the front end. The strips of plastic include a pair of plastic side pads. The side pads are removably secured to the bottom surface of the ski body and extend longitudinally along the ski body. The strips of plastic may also include a removable center keel. A wear bar or wear rod assembly may be fastened to the center keel.

### FIELD OF THE INVENTION

The present invention relates generally to snowmobiles, and more particularly relates snowmobile skis of snowmobiles.

### BACKGROUND OF THE INVENTION

Snowmobiles have a pair of skis at the front end. The skis include ski bodies that are adapted to ride over snow material. The ski bodies have mounting shoes towards the center of the ski for mounting to the front suspension posts of the snowmobile and an upwardly curved ski tip for keeping the ski afloat on the snow surface. Typically, the curved ski tip terminates in a structural loop which serves a protective function and also provides a handle for manually manipulating or moving the snowmobile.

There have been two approaches to providing the ski bodies of snowmobile skis. The first and most widely used method has been to form sheet metal material into the ski body. The ski body often includes a contoured profile that includes a deep trough in the center of its top surface thereby providing a center keel projecting downward along its bottom surface. Depending on its depth, the center keel provides a structure that can increase or decrease control and steering of the snowmobile in varying snow conditions.

The other approach has been to mold a plastic ski. All current commercial plastic snowmobile skis are formed by expensive molds. Not only is this expensive, but it also means that when any part of the ski is worn or damaged, a whole new ski has to be purchased. Plastic tends to be less durable than steel skis. Indeed, when one compares a new plastic ski with one that has been subject to moderate usage, it will be apparent that much of the contour and structure of the original plastic ski has wore away. It is thus known that plastic snowmobile skis wear out from time to time and need to be replaced which is costly.

A further limitation on both existing plastic and steel skis is that the snowmobile operator is basically limited to one ski configuration for all snow and trail conditions. While there has been a lot of effort within the industry to arrive at ski contours and profiles that provide certain snowmobile performance characteristics or benefits, the fact of the matter is that once the ski is bought, there is nothing that can be done to change the ski contour and profile. This is a disadvantage as snow conditions change throughout the snowmobile season. For example, there is often less snow at the beginning and at the end of the snowmobile season when it is desirable to have a flatter contoured or more neutral ski for better floatation, while there is often more snow during the middle of the season when it is more desirable to have a highly profiled ski that digs into the snow more for increased control. The fixed contour and profile limitations inherent with existing skis also limits a operator's ability to change between aggressive and passive styles of snowmobiling.

One other known difficulty in the snowmobile ski art is that of darting. Darting occurs due to the fact that snowmobile trails contain the long imprinted ruts of the skis of many different previous snowmobiles. When a snowmobile is traveling on a trail, the skis of the snowmobile tend to ride inside the already formed ruts, which in turn makes it more difficult for the snowmobile operator to control the snowmobile. The large number of ruts going various different directions often cause the snowmobile to “dart” or wander laterally from a straight path. An operator often has to overcompensate to steer the snowmobile, which leads to less control and operator fatigue. Many snowmobile skis existing today do not adequately remedy the darting problem. (i.e. Some use two wear rods per ski that straddle other ski ruts. However, similar skis will dart in these new ruts. Others dig a deeper rut overpowering the other or preexisting ruts.

### BRIEF SUMMARY OF THE INVENTION

In view of the foregoing, the present invention takes a new approach to providing or building a snowmobile ski by using strips of plastic for building the contour on the bottom surface of the snowmobile ski body. The strips of plastic may be used to build a new ski or rebuild or repair an existing snowmobile ski that has a center keel.

A snowmobile ski according to one aspect of the invention comprises a mounting shoe for mounting the snowmobile ski to the snowmobile and a longitudinally extending ski body comprised of plastic material and having an upwardly curved front tip toward the front end. The mounting shoe is disposed on the top surface on the ski body. The strips of plastic include a pair of pads comprised of plastic material. The pads are removably secured to the bottom surface of the ski body and extend longitudinally along the ski body.

The snowmobile ski typically will include a center keel disposed between the pair of pads that also extends longitudinally along the ski body. The pads are laterally spaced from the plastic center keel such that a pair of elongate channels are defined between the center keel and the side pads (with a channel bottom along the bottom surface of the ski body). For a new ski, the center keel may be a separate plastic strip secured to the bottom surface of the ski body. A removable wear rod assembly is fastened to the center keel. Such a removable wear rod assembly comprises a plastic wear strip and a metal wear rod in which the plastic wear strip is sandwiched between the metal wear rod and the center keel.

The invention is also directed toward a kit and a method of using the kit for building or repairing a snowmobile ski. The kit comprises a plurality of plastic strips for mounting to the bottom surface of the ski body or ski bodies in each plastic strip comprised of plastic material and being of a different size or contour. A person then selects at least one of the plurality of plastic strips based on a desired performance characteristic for the snowmobile ski and then mounts the selected at least one plastic strip to the bottom surface of the ski body.

Other objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a front elevation view of two snowmobile skis mounted on a snowmobile according an embodiment of the present invention.

FIG. 2 is a bottom view of one of the skis illustrated in FIG. 1.

FIG. 3 is a cross section of FIG. 2 taken about line 3-3.

FIG. 4 is a cross section of FIG. 2 taken about line 4-4.

FIG. 5 is an exploded isometric assembly drawing of the ski illustrated in FIG. 1.

FIG. 6 is a lateral cross section of the ski illustrated in FIG. 1.

FIGS. 7 and 8 are cross sections of a lateral end portion of skis according to alternative embodiments of the present invention.

FIG. 9 is a view similar to FIG. 7 but with different sizes of side pads and center reels.

FIG. 10 is a cross section similar to FIG. 7 but with a different configuration of pads and center keel.

FIG. 11 is a plastic cross section of a rebuilt ski according to an embodiment of the invention with an integral center keel.

FIG. 12 is an isometric rear comer view of a ski according to a further alternative embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

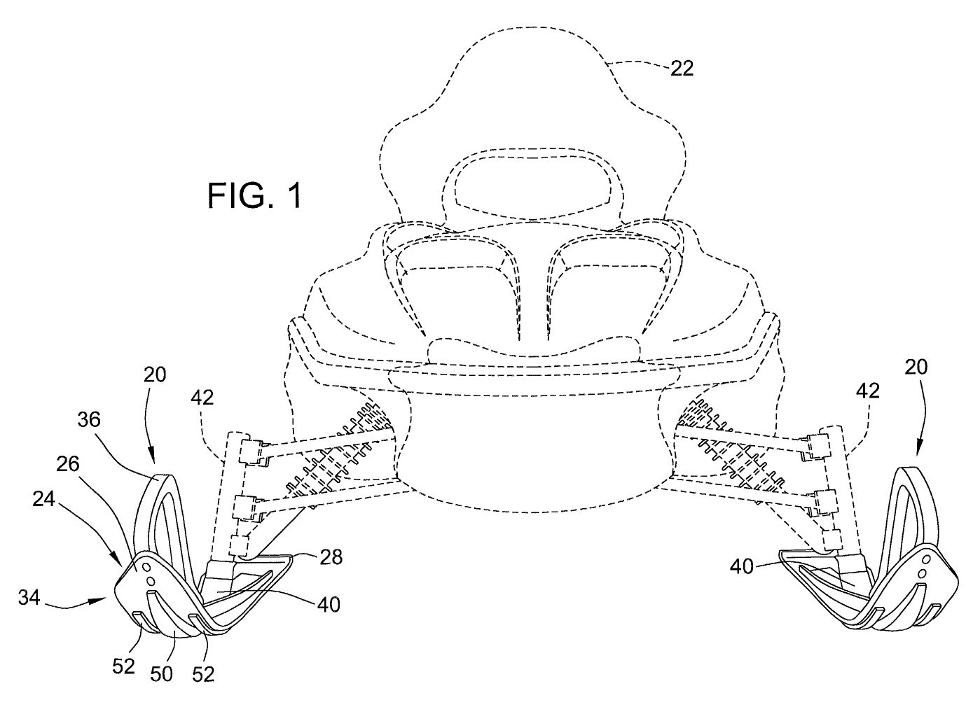

For purposes of illustration, a preferred embodiment of the present invention has been illustrated as a snowmobile ski 20 for mounting to the front end of a snowmobile 22 as shown in FIG. 1.

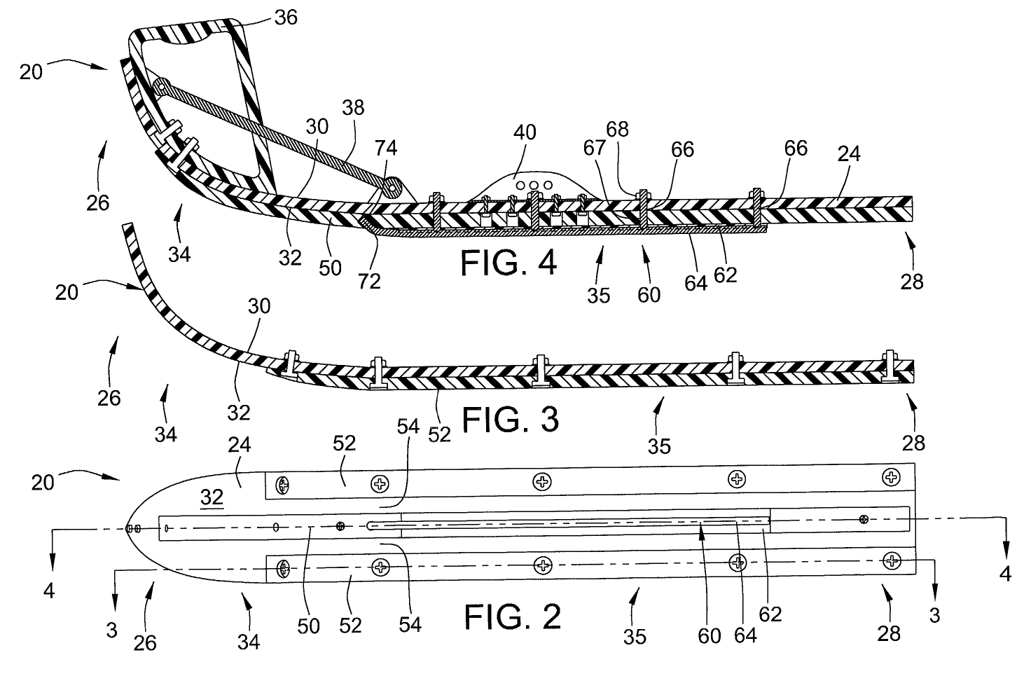

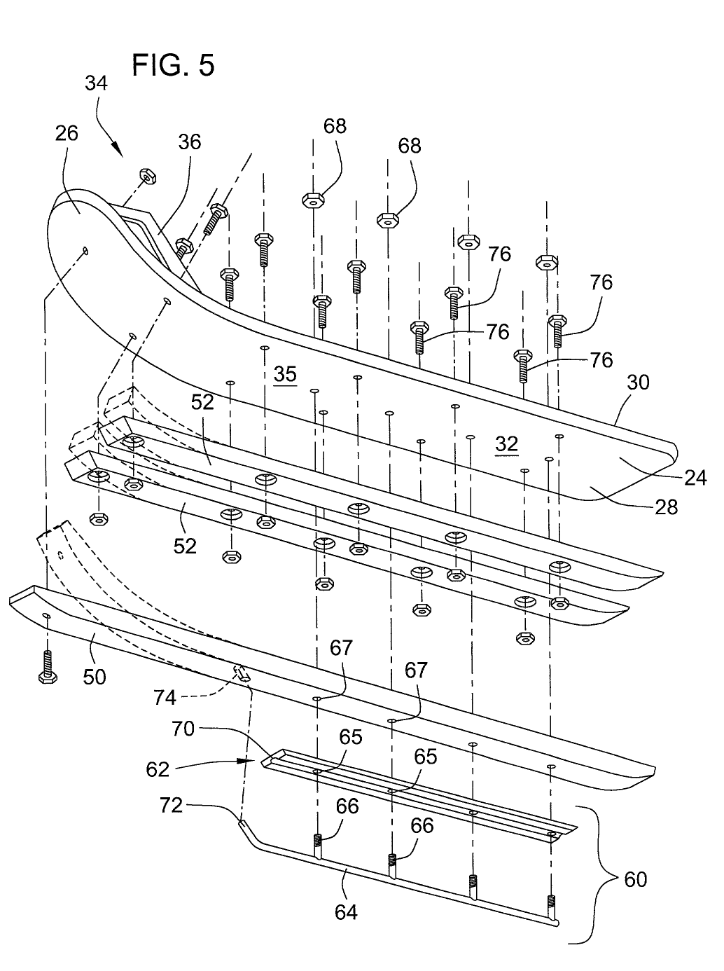

Referring to FIGS. 2-6, the snowmobile ski 20 includes a ski body 24 comprised of plastic material. For purposes of reference, the snowmobile ski 20 extends longitudinally and horizontally between a front end 26 and a rear end 28, and has generally flat top and bottom surfaces 30, 32. Toward the front end 26, the ski body 24 has an upwardly curved front tip 34 that serves to keep the ski 20 afloat on the snow surface when the snowmobile 22 is moving forward. The back portion 35 of the ski 20 is generally planar, but it will be appreciated that the overall ski contour may also be bowed in which the rear end of the ski may curve upwardly as well. To support the shape of the curved front tip 34, a diagonal support bar 38 is secured between the front end 26 and the front of the back portion 35 of the ski. A rigid loop structure 36 may also be mounted to the front end 26 to provide a handle for manually manipulating or moving the snowmobile 20 when it is stuck or otherwise needs to be moved manually. A mounting shoe 40 is secured to the top surface 30 of the ski body 24 towards the center of the ski 20 to provide for attachment of the ski 20 to one of the front vertically extending support posts of the snowmobile 22.

In accordance with the present invention, the contour of the snowmobile ski 20 is formed at least in part with plastic material strips mounted to the bottom surface 32 of the ski body or ski bodies 24. In the disclosed embodiment of FIGS. 2-6, the plastic material strips include a removable plastic center keel 50 and a pair of removable plastic side pads 52.

The center keel 50 extends longitudinally along the ski body 24 in a central location laterally between the side pads 52. The center keel 50 preferably extends substantially the entire length of the ski body or ski bodies 24 between front and back ends including through the front tip 34. The pads 52 are laterally spaced from the plastic center keel 50, such that a pair of elongate channels 54 are defined with a channel bottom along the bottom surface 32 of the ski body or ski bodies. The channels 54 are adapted to receive and channel snow therethrough such that the edges of the center keel 50 and/or side pads 52 are adapted to act on snow channeled through the channels 54 to assist in steering and control of the snowmobile 22. The pads 52 extend a substantial portion of the length of the ski 20 between the rear end 28 and through the rear portion of the front tip 34.

Preferably, the side center keel 50 projects vertically downward to a vertical elevation equal to or below that of the side pads 52. The deeper the center keel 50 projects vertical downward from the side pads 52, the more the center keel 50 will dig into and engage snow, thereby enhancing control. This is particularly advantageous in certain snow conditions such as deep snow conditions. However, for thinner snow conditions, it is often more desirable to have a flatter ski with the side pads 52 and center keel 50 are equal or more nuetral, lying in substantially the same plane. This keeps the bottom plane of the ski 20 more atop the snow surface prevent destruction of trails and preventing destruction of the center keel 50.

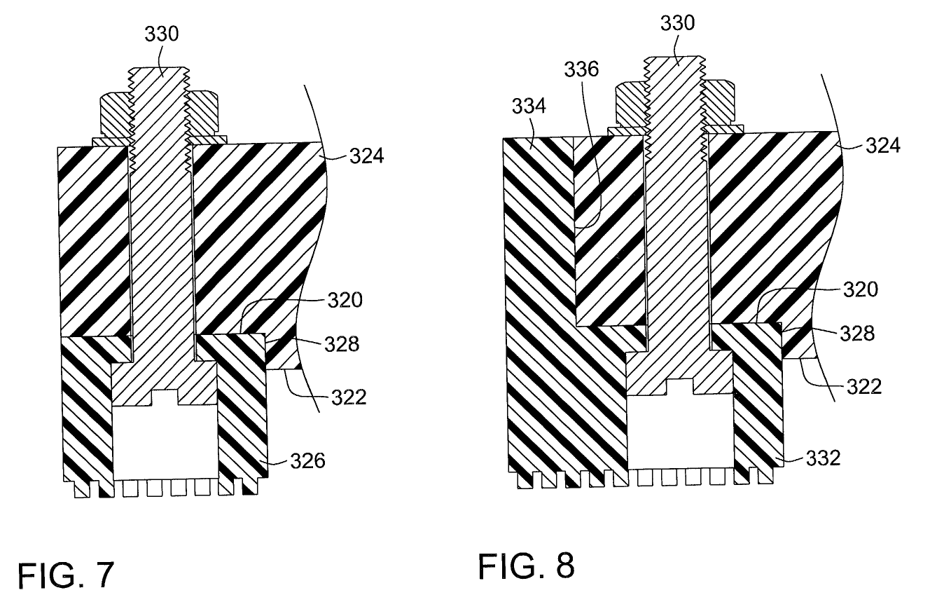

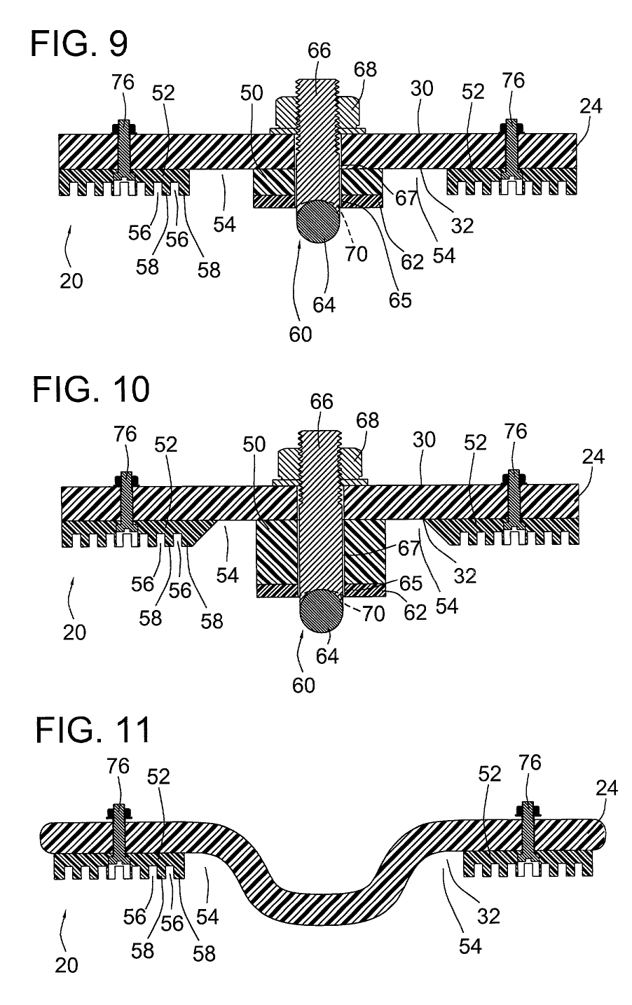

To provide for different ski conditions and different ski characteristics, the present invention is therefore also directed toward a kit having different sizes and contours of the center keel 50 and/or the side pads 52 (compare e.g. FIGS. 7, 9, and 10). Different relative vertical thicknesses between the side pads 52 and the center keel 50 can be selected to provide a desired performance characteristic. The relative vertical heights of the center keel 50 and the side pads 52 can be selected for a more aggressive ski, a more neutral ski or a characteristic therebetween. If desired, a snowmobile operator or mechanic may also remove the center keel or side pads of one thickness or contour and install a different thickness or contour to effectively modify the ski for the desired ski characteristic or snow condition.

In addition, different surfaces or contours for the center keel 50 and the side pads 52 may also be selected. For example, longitudinal grooves 56 or teeth 58 may be formed into the bottom of the side pads 52 to try to enhance performance and control characteristics. Wear characteristics and control characteristics can also be improved by attaching a wear rod assembly 60 (there are different wear rods configurations that are commercially available) to the underside of the ski 20. In the preferred embodiment, the wear rod assembly 60 is fastened to and forms part of the contour of the center keel 50. The wear rod assembly 60 may be similar to that disclosed in Bergstrom, U.S. Pat. No. 5,222,749, the entire disclosure of which is hereby incorporated by reference, and includes a plastic wear strip 62 and a metal wear rod 64. Briefly, the wear rod 64 has vertically extending mounting posts 66 that extend through holes 65 in the wear strip 62 and holes 67 in the center keel 50. Nuts 68 secured onto the mounting post 66 fasten the wear rod 64 to the center keel, with the plastic wear strip 62 sandwiched therebetween. A groove 70 in the plastic wear strip 62 receives the wear rod 64. In this embodiment, the front tip 72 of the wear bar is upwardly curved and projects into a cavity 74 formed in the underside of the center keel 50. The plastic wear strip 62 is substantially as wide laterally as the center keel 50 to cover the high wear region of the center keel 50 so that the wear bar assembly 60 protects the center keel 50 from excessive wear.

It will also be appreciated that although the side pads 52 and the center keel 50 are removable, that an operator may often be satisfied with the characteristic and performance of the ski, and may simply leave the side pads 52 and center keel 50 on the ski for its life. However, the ski 20 is flexible to allow for modifications and changes in the ski performance characteristic at a later date.

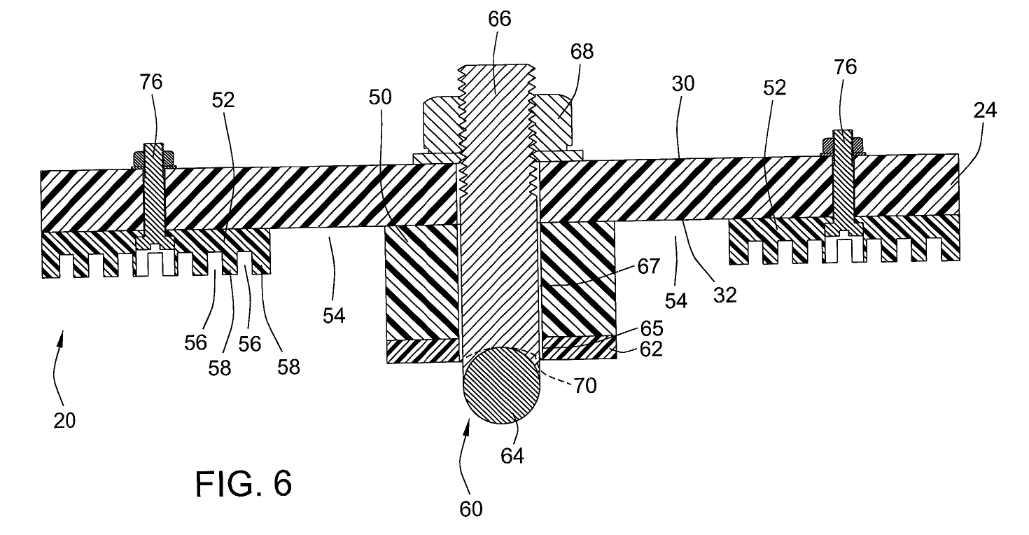

It will be appreciated that different mounting mechanisms may be used to removably secure the plastic strips to the bottom surface 32 of the ski body or ski bodies 24. FIGS. 6-11 illustrate a system where threaded screws 76 are used to removably secure the side pads 52 and center keel 50 to the ski body or ski bodies 24. The screws 76 may be plastic or metal and may be directly screwed into the plastic material of the ski body or ski bodies 24 or may extend through holes in the ski body or ski bodies 24 with a nut fastened over the screws on the top surface 30 of the ski body or ski bodies 24. Countersinks may be formed into the bottom of the side pads 52 and center keel 50 to better protect the screw head and keep the bottom surface of the ski 20 smoother. Plastic bolts may be threaded right into the keel and side pads.

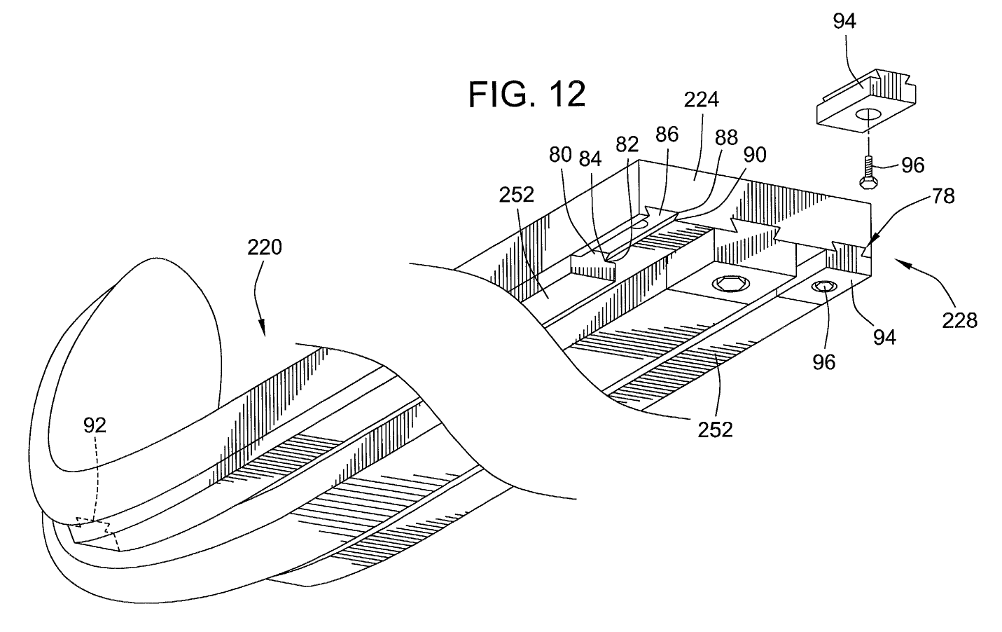

FIG. 12 illustrates a second system whereby interlocking dovetail joints 78 or other similar interlocking tongue and groove joint are employed to removably secure the side pads 152 (and center keel) to the ski body or ski bodies 224. The dovetail joint 78 includes a tongue 80 having an enlarged end 82 at its tip and a narrow neck near 84 its base that slides into a groove 86 with a corresponding enlarged section 88 and narrow neck section 90. The joint 78 provides vertical retention. According to this system, the side pads 252 slide into the ski body 224 at the rear end 228. A stop 92 formed integrally into the ski body 24 at the front end 26 limits the amount of sliding movement and positions the front end of the side pads 252. At the rear end 228, a backstop is provided by a clamp 94 removably secured to the ski body 224 via bolts 96. This system provides for quick installation and removal, allowing an operator to change the configuration of the ski 220 relatively quickly.

A further advantage of the disclosed embodiments is that the side pads 52, the center keel 50 and even the ski body 24 may all be machined or cut plastic from elongated plastic blocks having generally flat sides rather than molded plastic. This is due to the fact that the contour of the ski is built using substantially flat plastic strips that have some flexibility for bending at the tip ends. This allows for many different widths, thicknesses, contours and configurations of side pads 52, center keels 50 and ski bodies 24 to be formed to provide a ski that can be built to individual specifications without requiring expensive molds that would be unduly cost prohibitive. For high volume production, a manufacturer could also form the side pads 52, the center keel 50 and the ski body or ski bodies 24 with plastic molds if desired where the high volume would not be cost prohibitive.

Referring to FIG. 11, an embodiment of the present invention is shown in the form of a rebuilt or repaired ski 120. Many of the concepts of this embodiment are similar to the first embodiment, however, this embodiment is different in that the ski 120 comprises a pre-existing ski body 124 that integrally provides a center keel 150. The ski body 124 is comprised of molded plastic material and as such has a fixed contour. Such molded plastic skis are typically subject to high wear and need to be replaced. This embodiment includes side pads 152 fastened with bolts or screws 156 to the ski body 124 on opposing sides of the center keel 150 similar to the first embodiment. The side pads 152 form channels 154 on both sides of the center keel 150. The thickness of the side pads 152 can be selected from many different thicknesses to provide a desired performance characteristic for the ski 120. The side pads 152 are located in the area of high wear otherwise normally experienced for the ski body or ski bodies 124 and as such increase the durability and life-span of the ski. The side pads 152 also relieve the impact realized on the integral center keel 150 reducing wear at that location. Wear rod assemblies may also be secured to the center keel 150. Although the invention is most beneficial and solves significant durability problems related to plastic skis, it might also be desirable to use the invention for pre-existing metal skis to change the contour and provide for decreased wear.

Referring to FIGS. 7 and 8, further alternative embodiments of the present invention are illustrated. Both of these figures illustrate that a recess 320 may be formed into the bottom surface 322 of the ski body 324 to provide a location for receiving the side pad 326 (a central unshaped channel may also be used to receive the center keel as well for support purposes). The recess provides a vertical support wall 328 that supports the side pad 326 laterally, such that when the snowmobile is turning and the side pad is engaging snow, the lateral force applied to the side pad 326 is carried in part by the vertical support wall 328. This alleviates the stress incurred on the side pad 326 which is carried primarily through the mounting screw 330. FIG. 8 illustrates an embodiment substantially identical to FIG. 7, except that the side pad 332 includes an outer end flange wall 334 that is supported by the side edge 336 of the ski body or ski bodies 324 for additional lateral support. The end flange 334 also protects and provides for wear resistance against the outer edge 336 of the ski body or ski bodies 324.

All of the references cited herein, including patents, patent applications, and publications, are hereby incorporated in their entireties by reference.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A snowmobile ski for a snowmobile, comprising:
a mounting shoe for mounting the snowmobile ski to the snowmobile;
a ski body comprised of plastic material extending longitudinally between a front end and a rear end, the ski body having top and bottom surfaces, the mounting shoe disposed on the top surface, the ski body having an upwardly curved front tip toward the front end; and
a pair of pads comprised of plastic material, the pads being removably secured to the bottom surface extending longitudinally along the ski body.

2. The snowmobile ski of claim 2 further comprising a center keel disposed between the pair of pads extending longitudinally along the ski body or ski bodies, the pads being laterally spaced from the plastic center keel, such that a pair of elongate channels are defined between the center keel and the side pads with a channel bottom along the bottom surface of the ski body or ski bodies.

3. The snowmobile ski of claim 2 wherein the center keel is integrally formed with the plastic material of ski body.

4. The snowmobile ski of claim 2 wherein the center keel is a separate part comprised of plastic material removably secured to the bottom surface.

5. The snowmobile ski of claim 2 wherein the side center keel projects vertically downward to a vertical elevation equal to or below that of the side pads.

6. The snowmobile ski of claim 2, further comprising a removable wear rod assembly fastened to the center keel, the removable wear rod assembly comprising a plastic wear strip and a metal wear rod, the plastic wear strip sandwiched between the metal wear rod and the center keel.

7. The snowmobile ski of claim 6 wherein the plastic wear strip is substantially as wide laterally as the center keel.

8. The snowmobile ski of claim 1 wherein the pair of side pads are removably secured with screws, the screws adapted to be unfastened for removal of the side pads and the center keel.

9. The snowmobile ski of claim 1 wherein the ski body includes support recesses formed into the bottom surface thereof, the support recesses extending longitudinally along the bottom surface in spaced relation with a vertically projecting central portion therebetween, wherein each pad is seated in one of the recesses, each pad adapted to engage the central portion for lateral support.

10. The snowmobile ski of claim 1 wherein the ski body includes at least one support recess formed into the bottom surface thereof, the support recess extending longitudinally along the bottom surface, at least one of the pads being seated the at least one recess, the at least one of the pads adapted to engage an edge of the at least one support recess for lateral support.

11. The snowmobile ski of claim 1 further comprising an interlocking tongue and groove joint formed between each pad and the ski body for removably securing the pads to the ski body, the interlocking tongue and groove joint extending longitidunally along the snowmobile ski and comprising a tongue interfitting with a groove, the interlocking tongue and groove joint comprising a narrow section of the tongue and the groove proximate mating surfaces of the ski body and the pad and an enlarged bottom portion of the tongue and groove of a wider lateral thickness than the neck section vertically displaced from mating surfaces of the pad and the ski body, whereby the tongue and groove joint vertically retains the pads to the ski body.

12. The snowmobile ski of claim 1 wherein the groove is formed into the ski body or ski bodies and the tongue is formed into the pad for each tongue and groove joint, the groove extending through rear end and extending longitudinally until a stop surface formed integral with the ski body proximate the front end, whereby the tongue of the pad is inserted into the groove through the back end such that the tongue slides through the groove until engagement with the stop surface, the tongue and groove joint having a removable clamp adapted to be fastened and unfastened to the rear end of the ski body for locking the tongue in the groove.

13. The snowmobile ski of claim 12 wherein the interlocking tongue and groove joint is a dovetail joint.

14. The snowmobile ski of claim 1 wherein the pads comprise an exposed surface adapted to ride on snow material having a plurality of longitudinally extending grooves formed into the pads.

15. The snowmobile ski of claim 1 wherein the pads extend longitudinally along the ski body or ski bodies substantially an entire length between the rear end and the front tip.

16. A method of building or repairing a snowmobile ski for a snowmobile, comprising:
providing a ski body extending longitudinally between a front end and a rear end, the ski body having top and bottom surfaces, a mounting shoe disposed on the top surface, the ski body having an upwardly curved front tip proximate the front end;
providing a kit comprising a plurality of plastic strips for mounting to the bottom surface of the ski body or ski bodies, each plastic strip comprised of plastic material and being of a different size or contour;
selecting at least one of the plurality of plastic strips based on a desired performance characteristic for the snowmobile ski; and
mounting the selected at least one plastic strip to the bottom surface of the ski body or ski bodies.

17. The method of claim 16 wherein the ski body is comprised of plastic material, and wherein the plastic strips include a pair of side pads and a center keel, further comprising:
mounting the center keel to the bottom surface of the ski body, the center keel extending longitudinally along the bottom surface; and
mounting the pair of side pads to the ski body with one side pad one each side of the center keel, with the side pads spaced lateral from the center keel forming a pair of elongate channels defined between the center keel and the side pads with a channel bottom along the bottom surface of the ski body or ski bodies.

18. The method of claim 17 wherein the center keel is mounted in such a way that center keel projects vertically downward to a vertical elevation equal to or below that of the side pads.

19. The method of claim 18, further comprising:
selecting the side pads from a plurality of side pads of different vertical thicknesses based on the desired performance characteristic.

20. The method of claim 19 further comprising:
selecting the center keel from a plurality of center keels of different vertical thicknesses based on the desired performance characteristic.

21. The method of claim 17 wherein the ski body comprises a center keel extending centrally and longitudinally along the ski body or ski bodies, further comprising:
fastening a removable wear rod assembly to the center keel, the removable wear rod assembly comprising a plastic wear strip and a metal wear rod, the plastic wear strip sandwiched between the metal wear rod and the center keel.

22. The method of claim 16 wherein the ski body and the mounting shoe are part of a preexisting snowmobile ski of a snowmobile subjected to wear, wherein the ski body or ski bodies has a center keel extending longitudinally along the center of the ski body, wherein the mounting comprises:
fastening a pair of the plastic strips to the ski body with one plastic strip on each side of the center keel and in lateral spaced relation to the center keel such that a pair of elongate channels are defined between the center keel and the side pads with a channel bottom along the bottom surface of the ski body.

23. The method of claim 16 wherein the ski body and the mounting shoe are part of a preexisting snowmobile ski of a snowmobile subjected to wear, further comprising:
evaluating the preexisting snowmobile ski and determining at least one wear area on the ski body; and
fastening the at least one of the plurality of plastic strips over the at least one wear area.
